(19) United States
(12) Patent Application Publication
(10) Pub. No.: US 2026/0330278 A1
(43) Pub. Date: Oct. 22, 2026

(54) METHODS AND ARRANGEMENTS FOR DRIVING A QUANTUM MECHANICAL SYSTEM

(71) Applicant: IQM FINLAND OY, Espoo (FI)

(72) Inventors: Mikko MÖTTÖNEN, Espoo (FI); Akseli MÄKINEN, Espoo (FI)

(21) Appl. No.: 19/115,047

(22) PCT Filed: Sep. 30, 2022
(86) PCT No.: PCT/FI2022/050655

§ 371 Date: Mar. 25, 2025

(51) Int. Cl. G06N 10/40; G06F 17/16

(52) U.S. Cl. CPC G06N 10/40; G06F 17/16

(57) ABSTRACT

A bosonic quantum mechanical system capable of exhibiting transitions between a plurality of eigenstates is driven with two or more simultaneous driving signals, each of which has a respective driving signal amplitude, frequency, and phase. The two or more simultaneous driving signals are coupled to said quantum mechanical system through couplings of respective coupling strength at respective coupling locations in relation to a physical appearance of said system. A selected combination of said driving signal amplitudes, frequencies, and phases; said coupling strengths; and said coupling locations intentionally causes said driving to suppress at least one of said transitions.

### FIELD OF THE INVENTION

The invention is generally related to quantum information processing. In particular, the invention is related to hardware and methods that can be used to implement transitions between certain quantum states of the quantum information processing system while simultaneously suppressing certain other transitions.

### BACKGROUND OF THE INVENTION

Quantum information processing systems perform calculations using qubits, which are quantum mechanical systems with discrete energy spectra, used as effective two-level systems capable of exhibiting transitions between their states. FIG. 1 illustrates schematically a qubit 101, which can be driven by injecting a driving (or excitation) signal through a driving port 102. The state acquired by the qubit 101 can be read through a readout port 103. An optional bias signal, coupled to the qubit 101 through an optional bias port 104, can be used to affect the operating characteristics of the qubit 101, for example to change its resonance frequency or otherwise affect the way in which the qubit responds to drive and readout operations.

While it is conventional to describe quantum information processing using the two lowest energy states or basis states |0> and 1> of qubits, there may be a large or an infinite number of higher-energy states also. FIG. 2 illustrates schematically the basis states 201 and 202, as well as two higher-energy states 203 and 204. Driving a qubit with the intention of causing controlled transitions between the two basis states 201 and 202 tends to cause also transitions to, from, and between the higher-energy states 203 and 204. The occurrence of such transitions is often referred to as leakage out of the computational space or leakage error. It is possible to utilise at least some of the higher-energy states for certain aspects of advanced quantum information processing, but in conventional quantum information processing these transitions decrease the accuracy of the target operation, referred to as the gate fidelity. Consequently, any unintended higher-level transitions are to be suppressed to the extent possible.

A conventional way of suppressing higher-level transitions is to use sufficiently small amplitudes for the externally applied driving signals, also referred to sometimes as driving fields, that are used to drive the qubits. However, a small amplitude of a driving signal also makes the intended transitions between the basis states slower. The conventional method thus involves an awkward trade-off between gate time and fidelity.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a method and an arrangement for suppressing leakage error in a quantum information processing system. Another objective is to allow the designer of a quantum information processing system to decide about the desired strength of transitions between various energy states.

These and further advantageous objectives are achieved by using two or more simultaneous driving signals to a bosonic quantum mechanical system, and by selecting the parameter values associated with such two or more simultaneous driving signals in a way that suppresses unwanted transitions between energy states of the quantum mechanical system.

According to a first aspect, there is provided a method for driving a bosonic quantum mechanical system capable of exhibiting transitions between a plurality of eigenstates. The method comprises driving said quantum mechanical system with two or more simultaneous driving signals, each of which has a respective driving signal amplitude, frequency, and phase, and coupling said two or more simultaneous driving signals to said quantum mechanical system through couplings of respective coupling strength at respective coupling locations in relation to a physical appearance of said system. A selected combination of said driving signal amplitudes, frequencies, and phases; said coupling strengths; and said coupling locations intentionally causes said driving to suppress at least one of said transitions.

According to an embodiment, said coupling of said two or more simultaneous driving signals to said quantum mechanical system involves using capacitive coupling, so that said respective coupling strengths are functions of the capacitances of the respective capacitive couplings. This involves at least the advantage that the coupling strengths can be treated with accuracy in the mathematical model, on the basis of which the selections are made.

According to an embodiment, said driving signals are oscillating voltage signals, so that said respective driving signal amplitudes are amplitudes in voltage. This involves at least the advantages that the amplitudes can be treated with accuracy in the mathematical model, on the basis of which the selections are made, and that reasonably well known technologies can be used to generate the driving signals at the required accuracy.

According to an embodiment, the method comprises selecting values for said driving signal amplitudes, frequencies, and phases; coupling strengths; and coupling locations in a way that minimizes at least one transition matrix element M_{k,l} of a transition matrix between low-energy eigenstates of the quantum mechanical system caused by said driving signals, wherein k and l are indices of two of said eigenstates. This involves at least the advantage that the selections can be made systematically with well-established basis in theory.

According to an embodiment, said selecting of values for said driving signal amplitudes, frequencies, and phases; coupling strengths; and coupling locations comprises:
deriving the Hamiltonian of the bosonic quantum mechanical system under interest,
determining a low-energy eigenspace of the bosonic quantum mechanical system under interest by diagonalizing the Hamiltonian,
determining the formulae for the transition matrix elements M_{k,l} between low-energy eigenstates caused by drive fields of the bosonic quantum mechanical system, by calculating the overlap between said low-energy eigenstates against the drive Hamiltonian, said formulae being functions of the driving signal amplitudes, frequencies, and phases; and coupling strengths and the coupling locations,
solving the set of equations Mₖ_{ⱼ}_{,l}_{ⱼ}₌0 for all the index pairs (kⱼ,lⱼ) corresponding to states transitions between which are to be suppressed, and
selecting the driving signal amplitudes, frequencies, and phases; coupling strengths; and coupling locations given by the obtained solution. This involves at least the advantage that the selections can be made systematically with well-established basis in theory.

According to an embodiment, said bosonic quantum mechanical system is a part of a quantum information processing system. Two of said plurality of eigenstates may then be basis states of a computational basis of said quantum information processing system. Said selected combination of said driving signal amplitudes, frequencies, and phases; said coupling strengths; and said coupling locations intentionally drives a transition between said basis states and simultaneously causes said driving to suppress at least one further transition. This involves at least the advantage that leakage out of the computational space (or leakage error) may be decreased without having to use excessively small amplitudes for the driving signals.

According to an embodiment, said quantum mechanical system comprises a unimon, which comprises a coplanar waveguide, intercepted by at least one Josephson junction, and has a length between its two ends. Said coupling of said two or more simultaneous driving signals to said quantum mechanical system may then comprise coupling said driving signals to said unimon at respective two or more different locations along the length of said coplanar waveguide. This involves at least the advantage that the theory describing the operation of the system may be reduced into practice without excessively complicated hardware.

According to a second aspect, there is provided a quantum information processing system comprising a bosonic quantum mechanical system capable of exhibiting transitions between a plurality of eigenstates and one or more driving signal generators configured to generate driving signals with a respective driving signal amplitude, frequency, and phase. Said quantum information processing system is configured to drive said bosonic quantum mechanical system with two or more of said driving signals simultaneously, coupled to said quantum mechanical system through couplings of respective coupling strength at respective coupling locations in relation to a physical appearance of said system, in a selected combination of said driving signal amplitudes, frequencies, and phases; said coupling strengths; and said coupling locations to intentionally cause said driving to suppress at least one of said transitions.

According to an embodiment, two of said plurality of eigenstates are basis states of a computational basis of said quantum information processing system. Said quantum information processing system may then be configured to drive said bosonic quantum mechanical system with said selected combination of said driving signal amplitudes, frequencies, and phases; said coupling strengths; and said coupling locations to intentionally drive a transition between said basis states and to simultaneously cause said driving to suppress at least one further transition. This involves at least the advantage that leakage out of the computational space (or leakage error) may be decreased without having to use excessively small amplitudes for the driving signals.

According to an embodiment, said quantum mechanical system comprises at least one subsystem that is driven with said driving signals and utilized as a qubit or a qudit. This involves at least the advantage that the quantum mechanical system may be utilized to perform quantum computing operations.

According to an embodiment, the quantum information processing system comprises at least one unimon, which comprises a coplanar waveguide, intercepted by at least one Josephson junction, and has a length between its two ends. The quantum information processing system may then comprise couplings for coupling said two or more simultaneous driving signals to said unimon at respective two or more different locations along the length of said coplanar waveguide. This involves at least the advantage that the theory describing the operation of the system may be reduced into practice without excessively complicated hardware.

According to an embodiment, the quantum information processing system comprises:
a bias signals generator coupled to said bosonic quantum mechanical system and configured to generate bias signals for said bosonic quantum mechanical system,
a readout signals generator coupled to said bosonic quantum mechanical system and configured to generate readout signals for said bosonic quantum mechanical system,
an output signals processor coupled to said bosonic quantum mechanical system and configured to process output signals from said bosonic quantum mechanical system, and
an interfacing and control system coupled to said one or more driving signal generators, to said bias signals generator, to said readout signals generator, and to said output signals processor for controlling the operation of the quantum information processing system. This involves at least the advantage that the quantum information processing system may be utilised as a quantum computer.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates some basic concepts related to quantum information processing,

FIG. 2 illustrates an energy spectrum of a quantum mechanical system that may be used as a qubit,

FIG. 3 illustrates a unimon with capacitive couplings and an inductive element,

FIG. 4 illustrates a unimon with a plurality of couplings,

FIG. 5 illustrates the derivation of a linear part of the classical Hamiltonian in a certain case,

FIG. 6 illustrates a total Hamiltonian with the nonlinear part added,

FIG. 7 illustrates a further derived form of the Hamiltonian,

FIG. 8 illustrates a derived intermediate result for one inequality property between the indices,

FIG. 9 illustrates a derived intermediate result for one inequality property between the indices,

FIG. 10 illustrates a derived intermediate result for one inequality property between the indices,

FIG. 11 illustrates a derived intermediate result for one inequality property between the indices,

FIG. 12 illustrates a derived intermediate result for one inequality property between the indices,

FIG. 13 illustrates a derived intermediate result for one inequality property between the indices,

FIG. 14 illustrates a derived intermediate result for one inequality property between the indices,

FIG. 15 illustrates a derived intermediate result for one inequality property between the indices,

FIG. 16 illustrates a derived intermediate result for one inequality property between the indices,

FIG. 17 illustrates a form of the Hamiltonian in a two-mode case,

FIG. 18 illustrates the definitions of two parameters,

FIG. 19 illustrates a derived result for the ratio of two drive voltage amplitudes,

FIG. 20 illustrates a table of designed values of certain physical parameters of a system used for theoretical demonstration of validity,

FIG. 21 illustrates certain formulas and equations used for theoretical demonstration of the validity of the invention,

FIG. 22 illustrates a table of parameters derived using the designed values of the physical parameters of the system illustrated in FIG. 20,

FIG. 23 illustrates a circuit model of a unimon,

FIG. 24 illustrates an example arrangement of two unimons,

FIG. 25 illustrates an example arrangement of three unimons,

FIG. 26 illustrates an example arrangement of Josephson junctions in a unimon,

FIG. 27 illustrates an example arrangement of Josephson junctions in a unimon,

FIG. 28 illustrates an example arrangement of Josephson junctions in a unimon, and

FIG. 29 illustrates a quantum information processing system.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined in the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

The following description is related to bosonic quantum mechanical systems. A bosonic quantum mechanical system is one which exclusively comprises modes, the annihilation and creation operators of which obey the bosonic commutation relations. Alternatively, one may define a bosonic quantum mechanical system as one, the composite eigenstate of the position operator of which is symmetric under operation by an exchange operator. A bosonic quantum mechanical system meant here is capable of exhibiting transitions between at least three eigenstates, which may be called energy states and ordered according to increasing energy. Practical bosonic quantum mechanical systems have infinitely many such eigenstates, for which reason the expression plurality of eigenstates may be used. If the bosonic quantum mechanical system is a part of a quantum information processing system, two of said plurality of eigenstates may be considered as basis states of a computational basis of said quantum information processing system. However, to preserve generality, there is no need to make any assumptions about basis states at first in the following discussion.

In this text, a unimon is used as an example of a bosonic quantum mechanical system of the kind described above. A unimon is a bosonic quantum mechanical system that utilizes the cancellation of inductive and Josephson energies to enhance anharmonicity. This property is very useful, if the unimon is used for example as a qubit or qudit, in order to enable fast and high-fidelity single-qubit gates. The best-known form of a unimon at the date of writing this text is based on a grounded coplanar waveguide resonator with a single-embedded Josephson junction. Unimon has some interesting properties including a relatively high anharmonicity, protection against low-frequency charge noise and partial protection against magnetic flux noise. Experiments with such unimons agree well with the theoretical model and have allowed to reach single-qubit gate fidelities of 99.9%.

FIG. 3 shows schematically a unimon, which here has been formed mainly of superconducting patterns on the planar surface of an insulating substrate. The unimon of FIG. 3 comprises a coplanar waveguide 301 intercepted by a Josephson junction 302. In general, a unimon that comprises such a coplanar waveguide may comprise more than one Josephson junction. The concept and theoretical background of a unimon is treated in more detail later in this text.

The coplanar waveguide 301 has a certain length between its two ends. The quantum information processing system, of which the unimon of FIG. 3 is a part, may comprise couplings for coupling two or more simultaneous driving signals to the unimon. In FIG. 3, there are two such couplings, each having the physical form of a superconductive pattern 303 or 304 the end of which reaches close to the coplanar waveguide 301 at some point along its length. The partial enlargement 305 shows schematically how a capacitive coupling 306 is made to the coplanar waveguide 301 for capacitively coupling a driving signal thereto.

In particular, the couplings for coupling two or more simultaneous driving signals to the unimon are made at respective two or more different locations along the length of the coplanar waveguide 301. As an example,

FIG. 3 shows the distance 307 between the Josephson junction 302 and the point of closest distance from the end of the superconductive pattern 303 and the coplanar waveguide 301. The respective capacitive coupling can be considered to be made at said point. This point is closer to the left end of the coplanar waveguide 301 than the respective point for the other superconductive pattern 304 is to the right end of the coplanar waveguide 301. Additionally, the distance between the coupling point of the first superconductive pattern 303 and the Josephson junction 302 is different than the distance between the coupling point of the second superconductive pattern 304 and the Josephson junction 302. The definitions of distances can be made in various ways; for the viewpoint here, it is only important that—as mentioned above—the couplings for said two or more simultaneous driving signals to said unimon are made at respective two or more different locations along the length of said coplanar waveguide.

Additionally, FIG. 3 illustrates schematically an inductive element 308, here essentially a planar coil. The inductive element 308 may be used to create a difference of magnetic flux between the ground loops (here: the white, rectangular areas of no superconductive layer that separate the coplanar waveguide 301 from the surrounding ground plane).

Surprisingly, it has been found that if two or more drive fields are coupled simultaneously to a unimon like that in FIG. 3, a selected combination of driving signal amplitudes, frequencies, and phases; coupling strengths; and coupling locations may be made to intentionally cause said driving to suppress at least one of the unwanted transitions to, from, or between the higher-energy states.

In the example case of FIG. 3, the coupling of two or more simultaneous driving signals to the unimon (or, more generally: to the bosonic quantum mechanical system) involves using the capacitive couplings, of which coupling 306 is an example. In such a case the respective coupling strengths are functions of the capacitances of the respective capacitive couplings.

Most advantageously, but not necessarily, the driving signals are oscillating voltage signals, so that the respective driving signal amplitudes are amplitudes in voltage.

A more detailed mathematical background for said surprising effect is given later in this text. In general, it can be shown that said selecting of values for the driving signal amplitudes, frequencies, and phases; coupling strengths; and coupling locations is most advantageously made in a way that minimizes at least one transition matrix element M_{k,l} of a transition matrix between low-energy eigenstates of the quantum mechanical system caused by said driving signals, wherein k and 1 are indices of two of said eigenstates.

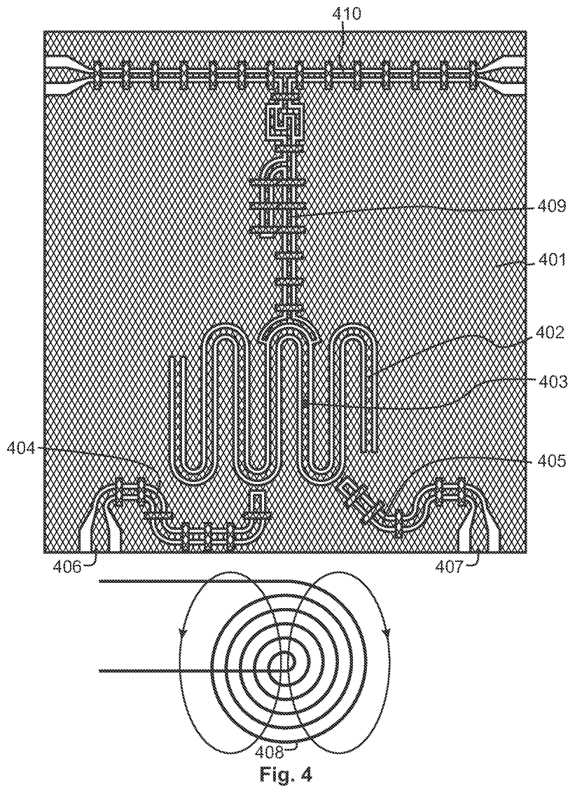

FIG. 4 shows schematically a part of a quantum processing circuit, which in turn may be part of a larger quantum information processing system. A surface of the quantum processing circuit is mostly covered with a superconductive ground layer 401. Circuit elements are manufactured on said surface by patterning. In the lower middle part is a unimon, which here represents an example of a bosonic quantum mechanical system. The unimon of FIG. 4 follows the same structural principle as that of FIG. 3, so that it comprises a coplanar waveguide 402 that is intercepted by (at least) one Josephson junction 403 and that has a length between its two ends.

The quantum processing circuit of FIG. 4 comprises two coupling elements 404 and 405. Each of these has a respective input 406 and 407 at an edge of the substrate. The quantum information processing system may use the coupling elements 404 and 405 to couple two or more simultaneous driving signals to the unimon (i.e. bosonic quantum mechanical system) at respective two different locations along the length of the coplanar waveguide 402.

The short sections of superconductive material that cross each of the coupling elements 404 and 405 at various locations represent airbridges that may be used to ensure that the ground potential is essentially the same at all parts of the ground plane, also around the superconductive patterns that have some specific function on the surface of the substrate. The airbridges also ensure that no excessively long ground current loops are formed at areas where they are not wanted.

Similar to FIG. 3, the quantum information processing system of which the circuit of FIG. 4 is part comprises an inductive element 408 for creating a difference of magnetic flux between the ground loops that surround the coplanar waveguide 402. The inductive element 408 may be located at a separate location, not on the surface of the same substrate as the coplanar waveguide 402 and the coupling elements 404 and 405.

As all bosonic quantum mechanical systems, the unimon in FIG. 4 has infinitely many eigenstates of which two may be considered as basis states of a computational basis of the quantum information processing system. The quantum information processing system is configured to utilise the coupling elements 404 and 405 to drive the unimon with a selected combination of driving signal amplitudes, frequencies, and phases; and coupling strengths. Together with the coupling locations, where the respective ends of the coupling elements 404 and 405 come closest to the coplanar waveguide 402, the effect is to intentionally drive a transition between said basis states and to simultaneously cause said driving to suppress at least one further transition. The further transition to be suppressed may be called a predetermined further transition, because the effect of properly selected combination of driving signal amplitudes, frequencies, and phases; coupling strengths; and coupling locations is known to the designer. Consequently, by making an informed selection, the designer may decide, which further transition(s) to suppress.

Further exemplary circuit elements of the quantum processing circuit of FIG. 4 are a readout resonator 409 and an output line 410. Similar to the coupling elements 404 and 405, these are formed of superconducting patterns on the surface of the substrate and crossed at multiple locations by airbridges that connect the ground plane sections on each side of such superconducting patterns.

In the following, a mathematical analysis is provided to show how a particular selection of parameters related to the couplings can be made to suppress unwanted transitions to, from, and/or between the higher-energy states of a bosonic quantum mechanical system.

A Hamiltonian can be derived for a capacitively driven multimode unimon at the presence of external magnetic flux, following the practice applied in O. Kiuru: “Use of a single circuit for a superconducting qubit and its readout”, Bachelor's thesis, University of Helsinki, Helsinki, Finland 2021 and E. Hyyppa: “Island-fee superconducting qubit”, Master's thesis, Aalto University, Espooo, Finland 2020. The Lagrangian of N drives at the locations x_{g,n} with voltages V_{g,n} and coupling capacitances C_{g,n} coupled to the multimode unimon is

$${ℒ}_{d} = \frac{1}{2} {\sum }_{m \geq 1} {\sum }_{n = 1}^{N} {{C}_{g , n} ( {\dot{ϕ}}_{m} \frac{{u}_{m} ( {x}_{g , n} )}{Δ {u}_{m}} - {V}_{g , n} )}^{2} \qquad ( 1 )$$

where φₘ is the flux across the Josephson junction, * denotes the temporal derivative, uₘ(x) denotes the envelope function of the m-th normal mode of the unimon at x, and Δuₘ denotes the discontinuity of the envelope function across the junction.

The kinetic energy and the potential energy of the non-driven multimode unimon are

$$T = {\sum }_{m \geq 1} \frac{{C}_{m}^{′}}{2} {\dot{ϕ}}_{m}^{2} , \qquad ( 2 )$$

$$and$$

$$U \approx {\sum }_{m \geq 1} \frac{{ϕ}_{m}^{2}}{2 {L}_{m}^{′}} + {U}_{n 1} ( {\sum }_{m \geq 1} {ϕ}_{m} ) , \qquad ( 3 )$$

$${U}_{nl} ( x ) = {E}_{J} cos ( \frac{2 {πϕ}_{0}}{{Φ}_{0}} ) {\sum }_{k = 2}^{∞} \frac{{( - 1 )}^{k + 1}}{( 2 k ) !} {( \frac{2 π x}{{Φ}_{0}} )}^{2 k} + {E}_{J} sin ( \frac{2 {πϕ}_{0}}{{Φ}_{0}} ) {\sum }_{k = 2}^{∞} \frac{{( - 1 )}^{k + 1}}{( 2 k + 1 ) !} {( \frac{2 π x}{{Φ}_{0}} )}^{2 k + 1} , \qquad ( 4 )$$

respectively, where

$${C}_{m}^{′} = ( 2 {c}_{tot} 1 + {C}_{J} ) / {( Δ {u}_{m} )}^{2} ,$$

cₜₒₜ is the total capacitance per unit length, 2l is the length of the center conductor of the unimon, C_{J} is the capacitance of the Josephson junction,

$${L}_{m}^{′} = {{L}_{m} ( Δ {u}_{m} )}^{2} ,$$

Lₘ is the effective inductance of the m-th mode, E_{J} is the Josephson energy, φ₀ denotes the coefficient of the dc mode in units of flux, and φ₀ is the flux quantum. Thus, the Lagrangian of the non-driven unimon reads

$$ℒ = T - U = {\sum }_{m \geq 1} ( \frac{{C}_{m}^{′}}{2} {\dot{ϕ}}_{m}^{2} - \frac{{ϕ}_{m}^{2}}{2 {L}_{m}^{′}} ) - {U}_{nl} ( {\sum }_{m \geq 1} {ϕ}_{m} ) . \qquad ( 5 )$$

Let us first derive the linear part of the total Hamiltonian from the linear part of the total Lagrangian [symbol] ₜₒₜ= [symbol] + [symbol] _{d},

$${ℒ}_{1} = {\sum }_{m \geq 1} ( \frac{{C}_{m}^{′}}{2} {\dot{ϕ}}_{m}^{2} - \frac{{ϕ}_{m}^{2}}{2 {L}_{m}^{′}} ) + \frac{1}{2} {\sum }_{m \geq 1} {\sum }_{n = 1}^{N} {{C}_{g , n} ( {\dot{ϕ}}_{m} \frac{{u}_{m} ( {x}_{g , n} )}{Δ {u}_{m}} - {V}_{g , n} )}^{2} . \qquad ( 6 )$$

The conjugate charge is PGP-29E

$$\begin{matrix}{q}_{m} = \frac{\partial {ℒ}_{1}}{\partial {\dot{ϕ}}_{m}} \\ = {C}_{m}^{′} {\dot{ϕ}}_{m} + {\sum }_{n = 1}^{N} {C}_{g , n} \frac{{u}_{m} ( {x}_{g , n} )}{Δ {u}_{m}} ( {\dot{ϕ}}_{m} \frac{{u}_{m} ( {x}_{g , n} )}{Δ {u}_{m}} - {V}_{g , n} ) .\end{matrix} \qquad ( 7 )$$

solving which for the temporal derivative of the flux across the junction gives

$${\dot{ϕ}}_{m} = \frac{{q}_{m} + {\sum }_{n = 1}^{N} {C}_{g , n} \frac{{u}_{m} ( {x}_{g , n} )}{Δ {u}_{m}} {V}_{g , n}}{{C}_{m}^{′} + {\sum }_{n = 1}^{N} {{C}_{g , n} ( \frac{{u}_{m} ( {x}_{g , n} )}{Δ {u}_{m}} )}^{2}} . \qquad ( 8 )$$

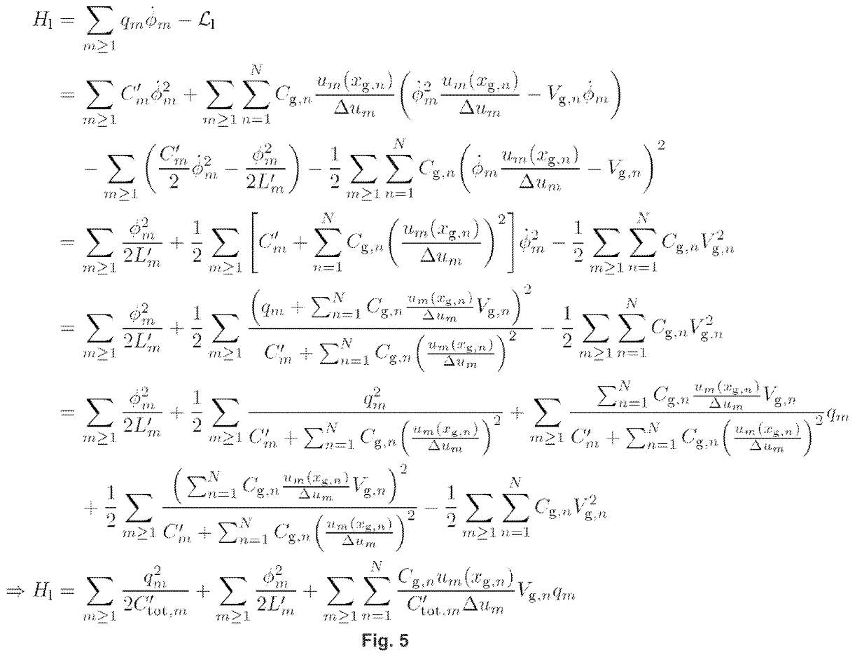

The linear part of the classical Hamiltonian may be obtained by performing the Legendre transform on the linear part of the Lagrangian. This is shown in FIG. 5, where we have defined

$${C}_{tot , m}^{′} := [ 2 {c}_{tot} l + {C}_{J} + {\sum }_{n = 1}^{N} {{C}_{g , n} ( {u}_{m} ( {x}_{g , n} ) )}^{2} ] / {( Δ {u}_{m} )}^{2}$$

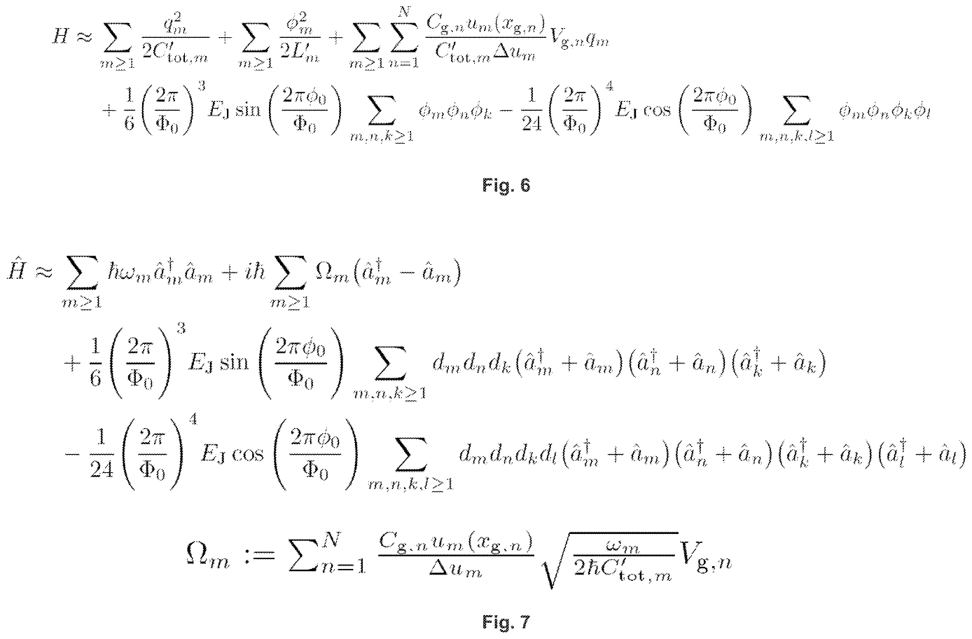

and ignored the constant energy offsets. To obtain the total Hamiltonian, we add the nonlinear part of the potential energy up to the fourth order to the Hamiltonian. This is shown in FIG. 6.

By imposing the canonical commutation relations between the coordinate-conjugate-momentum pairs,

[\hat{φ}ₘ,\hat{q}ₙ]=iℏδₘₙ, (9)

[\hat{φ}ₘ,\hat{φ}ₙ=0, (10)

[\hat{q}ₘ,\hat{q}ₙ=0, (11)

we quantize the above-derived classical Hamiltonian to obtain

$$\hat{H} \approx {\sum }_{m \geq 1} \frac{{\hat{q}}_{m}^{2}}{2 {C}_{tot , m}^{′}} + {\sum }_{m \geq 1} \frac{{\hat{ϕ}}_{m}^{2}}{2 {L}_{m}^{′}} {\sum }_{m \geq 1} {\sum }_{n = 1}^{N} \frac{{C}_{g , n} {u}_{m} ( {x}_{g , n} )}{{C}_{tot , m}^{′} Δ {u}_{m}} {V}_{g , n} {\dot{q}}_{m} + \frac{1}{6} {( \frac{2 π}{{Φ}_{0}} )}^{3} {E}_{J} sin ( \frac{2 {πϕ}_{0}}{{Φ}_{0}} ) {\sum }_{m , n , k \geq 1} {\hat{ϕ}}_{m} {\hat{ϕ}}_{n} {\hat{ϕ}}_{k} - \frac{1}{24} {( \frac{2 π}{{Φ}_{0}} )}^{4} {E}_{J} cos ( \frac{2 {πϕ}_{0}}{{Φ}_{0}} ) {\sum }_{m , n , k , l \geq 1} {\hat{ϕ}}_{m} {\hat{ϕ}}_{n} {\hat{ϕ}}_{k} {\hat{ϕ}}_{l} . \qquad ( 12 )$$

In terms of the annihilation and creation operators of each mode, implicitly defined as

$${\hat{ϕ}}_{m} = \sqrt{\frac{ℏ}{2 {C}_{tot , m}^{′} {ω}_{m}}} ( {\hat{a}}_{m}^{†} + {\hat{a}}_{m} ) \qquad ( 13 )$$

$$= : {d}_{m} ( {\hat{a}}_{m}^{†} + {\hat{a}}_{m} ) , \qquad ( 14 )$$

$${\hat{q}}_{m} = i \sqrt{\frac{ℏ {C}_{tot , m}^{′} {ω}_{m}}{2}} ( {\hat{a}}_{m}^{†} + {\hat{a}}_{m} ) , \qquad ( 15 )$$

and after applying the rotating-wave approximation where guaranteed to be applicable and neglecting the constant energy offsets, the Hamiltonian has the form shown in FIG. 7, with the appended definition of Ωₘ. To neglect the constant energy offsets and apply the rotating-wave approximation to the terms on the second and third line of the Hamiltonian, we open the brackets and consider separately the following cases with different inequality properties between the indices.

Second line, case m=n=k: There is 1 allowed permutation of the index labels. Thus,

$${\hat{ϕ}}_{m}^{3} = {d}_{m}^{3} ( {\hat{a}}_{m}^{†} + {\hat{a}}_{m} ) ( {\hat{a}}_{m}^{†} + {\hat{a}}_{m} ) ( {\hat{a}}_{m}^{†} + {\hat{a}}_{m} ) \approx 0. \qquad ( 16 )$$

Second line, case m=k<n: There are 3 allowed permutations of the index labels. Thus,

$$\begin{matrix}3 {\hat{ϕ}}_{m}^{2} {\hat{ϕ}}_{n} = 3 {d}_{m}^{2} {{d}_{n} ( {\hat{a}}_{m}^{†} + {\hat{a}}_{m} )}^{2} ( {\hat{a}}_{n}^{†} + {\hat{a}}_{n} ) \\ = 3 {d}_{m}^{2} {d}_{n} ( {\hat{a}}_{m}^{†2} + 2 {\hat{a}}_{m}^{†} {\hat{a}}_{m} + 1 + {\hat{a}}_{m}^{2} ) ( {\hat{a}}_{n}^{†} + {\hat{a}}_{n} ) \\ \approx 3 {d}_{m}^{2} {d}_{n} ( {\hat{a}}_{m}^{†2} {\hat{a}}_{n} + {\hat{a}}_{m}^{2} {\hat{a}}_{n}^{†} ) .\end{matrix} \qquad ( 17 )$$

Second line, case m<n=k: There are 3 allowed permutations. Thus,

$$\begin{matrix}3 {\hat{ϕ}}_{m} {\hat{ϕ}}_{n}^{2} = 3 {d}_{m} {d}_{n}^{2} ( {\hat{a}}_{m}^{†} + {\hat{a}}_{m} ) {( {\hat{a}}_{n}^{†} + {\hat{a}}_{n} )}^{2} \\ = 3 {d}_{m} {d}_{n}^{2} ( {\hat{a}}_{m}^{†} + {\hat{a}}_{m} ) ( {\hat{a}}_{n}^{†2} + 2 {\hat{a}}_{n}^{†} {\hat{a}}_{n} + 1 + {\hat{a}}_{n}^{2} ) \\ \approx 0.\end{matrix}$$

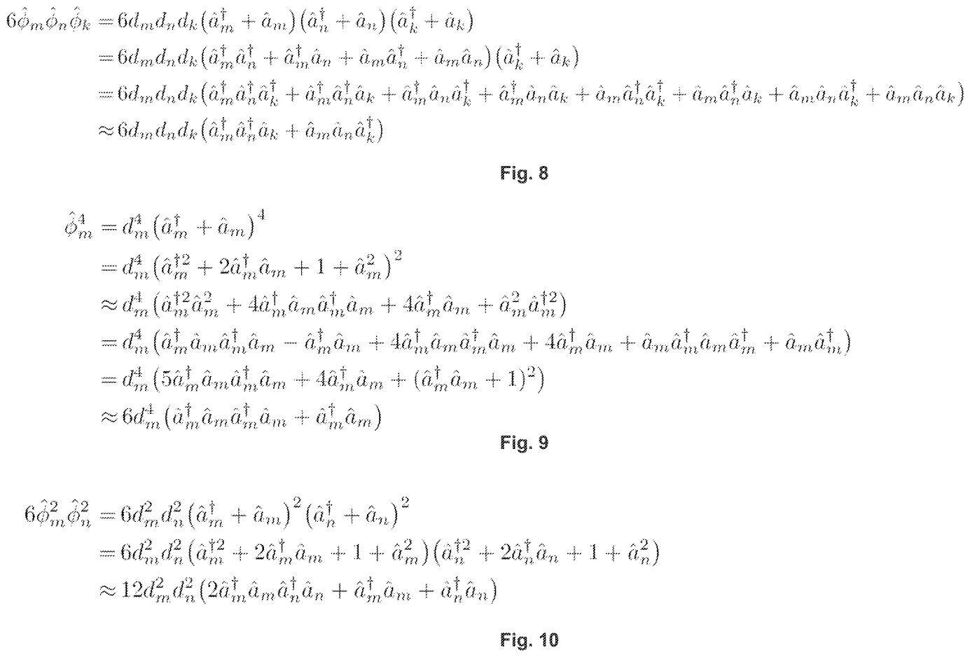

Second line, case m<n<k: There are 6 equivalent permutations. This leads to the conclusion shown in FIG. 8.

Third line, case m=n=k=l: There is 1 allowed permutation. This leads to the conclusion shown in FIG. 9.

Third line, case m=k<n=l: There are 6 equivalent permutations. This leads to the conclusion shown in FIG. 10.

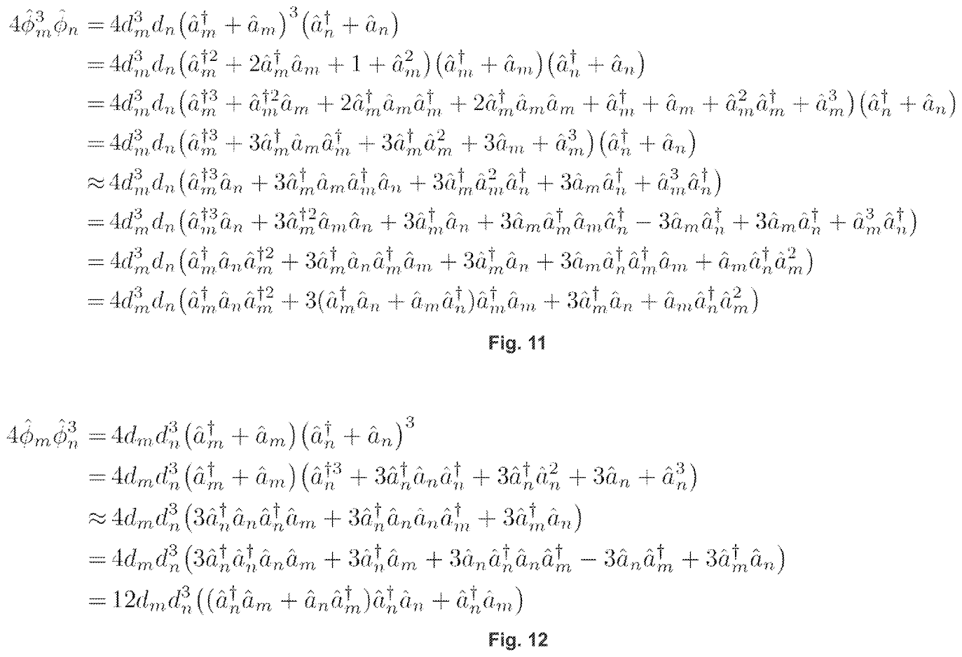

Third line, case m=k=l<n: There are 4 equivalent permutations. This leads to the conclusion shown in FIG. 11.

Third line, case m<n=k=l: There are 4 equivalent permutations. This leads to the conclusion shown in FIG. 12.

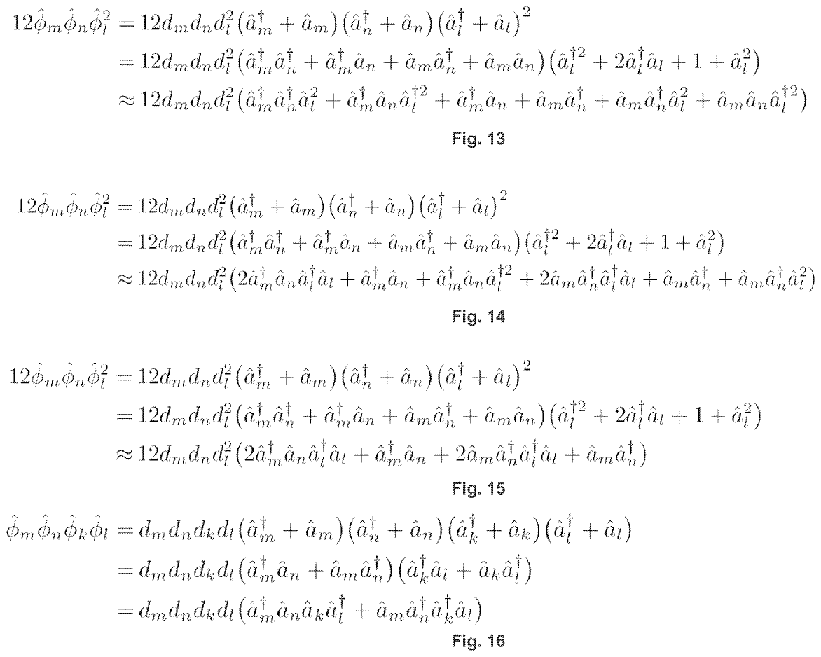

Third line, case m<k=l<n: There are 12 equivalent permutations. This leads to the conclusion shown in FIG. 13.

Third line, case k=l<m<n: There are 12 equivalent permutations. This leads to the conclusion shown in FIG. 14.

Third line, case m<n<k=l: There are 12 equivalent permutations. This leads to the conclusion shown in FIG. 15.

Third line, case m<n<k<l: There is 1 allowed permutation. This leads to the conclusion shown in FIG. 16.

Here we have not neglected terms corresponding to multi-photon processes. For brevity, we do not produce here the full Hamiltonian under the rotating-wave approximation based on the above analysis.

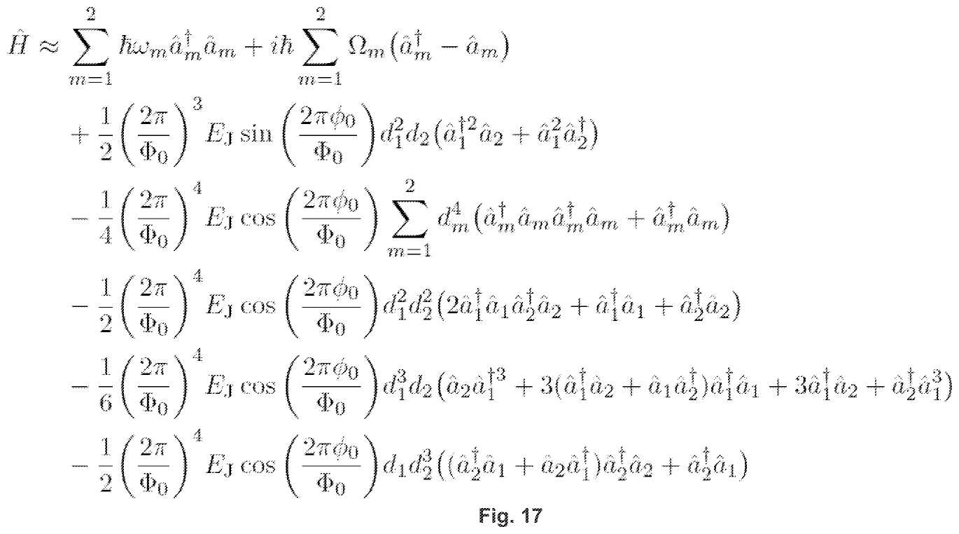

Under the approximation that the unimon comprises two modes, its Hamiltonian based on the above discussion has the form shown in FIG. 17.

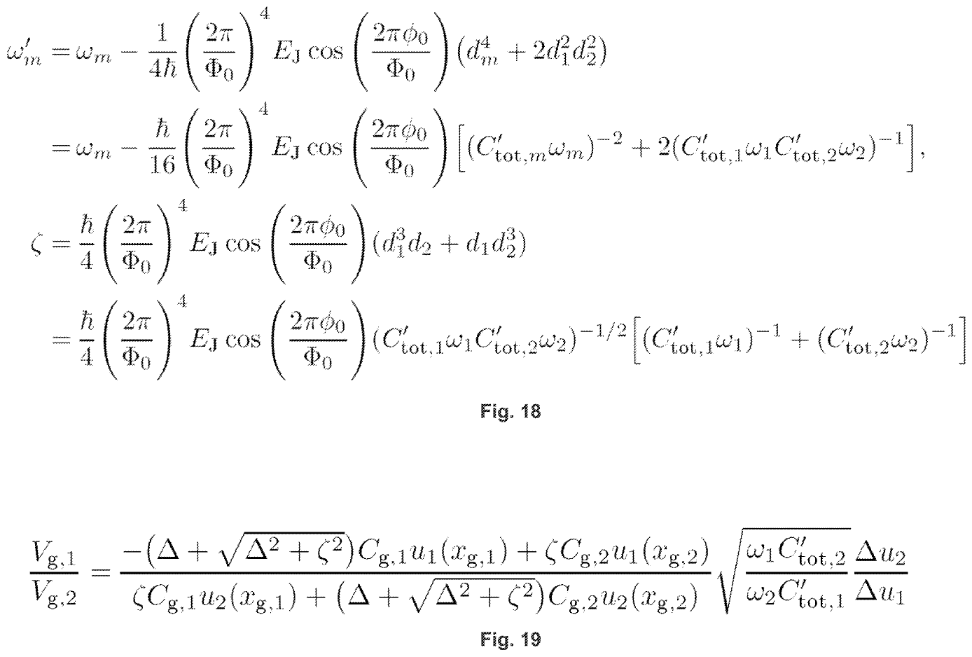

The ground state of the non-driven (Ω₁=Ω₂=0) Hamiltonian is

|g [symbol] |00 [symbol] , (19)
where |kl [symbol] denotes the number state of the two-mode unimon with k and l excitations in the first and second mode, respectively. The first and second excited states |e [symbol] and |f [symbol] are obtained by diagonalizing the single-excitation non-driven Hamiltonian, expressed in the basis {|10 [symbol] , |01 [symbol] } as a matrix as

$${\hat{H}}_{1} / ℏ = [ \begin{matrix}{ω}_{1}^{′} & - ζ / 2 \\ - ζ / 2 & {ω}_{2}^{′}\end{matrix} ] , \qquad ( 20 )$$

where the definitions of ω′ₘ and ζ are as shown in FIG. 18.

The diagonalization yields

$$\vert e 〉 = \frac{1}{\sqrt{2 {Δ}^{2} + 2 {ζ}^{2} - 2 Δ \sqrt{{Δ}^{2} + {ζ}^{2}}}} [ ( Δ - \sqrt{{Δ}^{2} + {ζ}^{2}} ) \vert 10 〉 + ζ \vert 01 〉 ] , \qquad ( 21 )$$

$$\vert f 〉 = \frac{1}{\sqrt{2 {Δ}^{2} + 2 {ζ}^{2} - 2 Δ \sqrt{{Δ}^{2} + {ζ}^{2}}}} [ ( Δ - \sqrt{{Δ}^{2} + {ζ}^{2}} ) \vert 10 〉 + ζ \vert 01 〉 ] , \qquad ( 22 )$$

where

$$Δ = {ω}_{2}^{′} - {ω}_{1}^{′} .$$

The transitions due to the drive Hamiltonian iltonian

$${\hat{H}}_{d} = \frac{i ℏ}{2} {\sum }_{m = 1}^{2} {Ω}_{m} ( {e}^{- i {ω}_{d} t} {\hat{a}}_{m}^{†} - {e}^{+ i {ω}_{d} t} {\hat{a}}_{m} ) \qquad ( 23 )$$

between the three lowest energy states are

$$〈 g \vert {\hat{H}}_{d} \vert e 〉 = \frac{i ℏ}{2} \frac{- {Ω}_{1} ( Δ - \sqrt{{Δ}^{2} + {ζ}^{2}} ) - {Ω}_{2} ζ}{\sqrt{2 {Δ}^{2} + 2 {ζ}^{2} - 2 Δ \sqrt{{Δ}^{2} + {ζ}^{2}}}} {e}^{+ i {ω}_{d} t} , \qquad ( 24 )$$

$$〈 g \vert {\hat{H}}_{d} \vert f 〉 = \frac{i ℏ}{2} \frac{- {Ω}_{1} ( Δ + \sqrt{{Δ}^{2} + {ζ}^{2}} ) - {Ω}_{2} ζ}{\sqrt{2 {Δ}^{2} + 2 {ζ}^{2} - 2 Δ \sqrt{{Δ}^{2} + {ζ}^{2}}}} {e}^{+ i {ω}_{d} t} , \qquad ( 25 )$$

$$〈 e \vert {\hat{H}}_{d} \vert f 〉 = 0. \qquad ( 26 )$$

To derive equation 23, we have set V_{g,1}→V_{g,1} cos (ω_{d}t) and V_{g,2}→V_{g,2} cos (ω_{d}t) and applied the rotating-wave approximation. Here, od is the angular frequency of the drive signals. Note that while in general the drive frequencies of the two drive signals may be different from each other, it can be shown that to completely suppress the gf-transition by tuning the drive voltage amplitudes, the drive frequencies need to equal.

Consequently, we can completely suppress the gf-transition by choosing the drive amplitudes and phases of the modes such that

$$\frac{{Ω}_{1}}{{Ω}_{2}} = - \frac{ζ}{Δ + \sqrt{{Δ}^{2} + {ζ}^{2}}} . \qquad ( 27 )$$

Plugging in the expressions for Ωₘ and solving for V_{g,1}/V_{g,2} finally gives the relation of the two voltage amplitudes V_{g,1} and V_{g,2} as shown in FIG. 19.

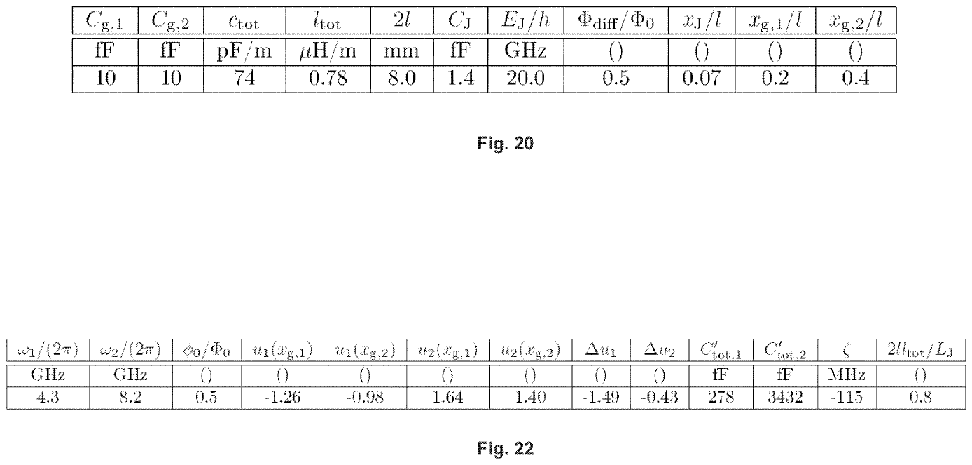

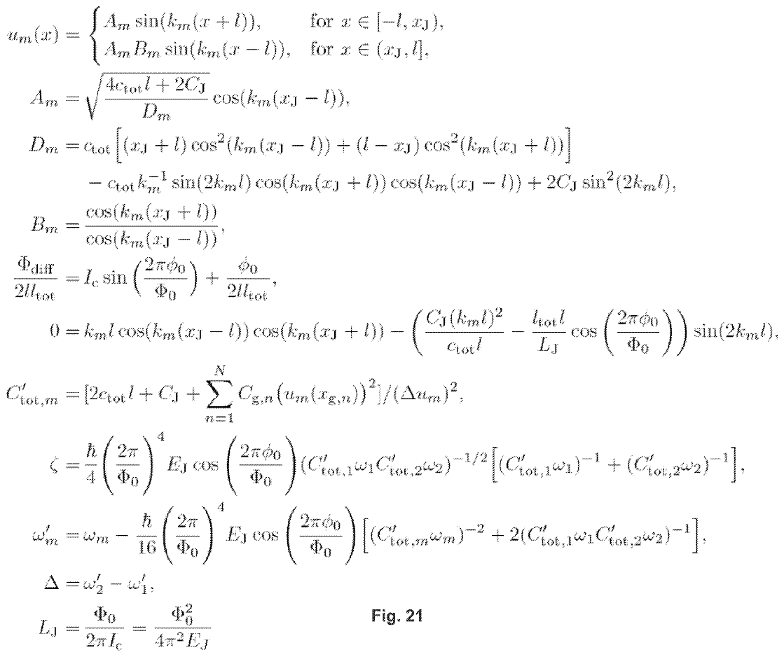

To theoretically demonstrate the feasibility of the invention, one may use the design values shown in the table of FIG. 20 and the collection of formulas and equations in FIG. 21, to calculate the parameters shown in the table of FIG. 22. Justification for using the values shown in FIG. 20 and the formulas and equations shown in FIG. 21 may be found in one of the references mentioned already earlier, namely O. Kiuru: “Use of a single circuit for a superconducting qubit and its readout”, Bachelor's thesis, University of Helsinki, Helsinki, Finland 2021. Importantly, the required ratio between the voltage amplitudes for the given set of parameters is V_{g,1}/V_{g,2}=0.66, which is feasible to realize experimentally.

Certain assumptions made in the process involve assuming the effect of the coupling capacitances to the drive lines negligible such that one may use the formula on the seventh line of FIG. 21 to obtain the wavenumbers. This is assumed to be a decent approximation for the given parameters, as the capacitance of the unimon waveguide is in any case about two orders of magnitude larger than the coupling capacitances of the drive lines.

To derive the conditions for the drive amplitudes, phases, and frequencies; and the locations and strengths of the couplings to suppress unwanted transitions in multimode bosonic quantum systems other than that described above, one may employ the following process. First, derive the Hamiltonian of the multimode system under interest, followed by determining its low-energy eigenspace by diagonalizing the Hamiltonian. Second, determine the formulae for the transition matrix elements M_{k,l} between the low-energy eigenstates caused by the drive fields by calculating the overlap between the states against the drive Hamiltonian. These formulae are functions of the drive amplitudes, phases, and frequencies; and the locations and strengths of the couplings. Third, solve the set of equations Mₖ_{ⱼ}_{,l}_{ⱼ}₌0 for all the index pairs (kⱼ,lⱼ) corresponding to states transitions between which are to be suppressed. The solution yields the desired conditions.

In the following, some background information is given for better understanding the concept of a unimon. The same background information can be found in a co-pending European patent application number 20213787.3, published on 15 Jun. 2022 as EP4012627A1, of the same applicant.

The superconducting phase difference of a circuit element may refer to a physical magnitude defined

$$φ ( t ) = \frac{2 π}{{Φ}_{0}} {\int }_{- ∞}^{t} V ( τ ) d τ , \qquad ( 28 )$$

where φ(t) is the superconducting phase difference at time t, V(t) is the corresponding voltage difference across the circuit element, Φ₀=h/(2e) is the flux quantum, and e is the electron charge. Note that the superconducting phase difference is related to a corresponding branch flux via a scale transformation.

The linear inductive-energy elements may be represented by geometric or linear inductors. In the exemplary embodiments disclosed herein, a geometric or linear inductor may refer to a superconducting inductor having a geometric inductance that may be defined as

L=Φ/I, (29)

where I denotes the electric current through the inductor, and Φ denotes the magnetic flux generated by the current. The geometric inductance depends on the geometry of the inductor. For example, the geometric inductor may be implemented as a wire, coil, or a center conductor of a distributed-element resonator (in particular, a CPW resonator), depending on particular applications.

The non-linear inductive-energy elements may be represented by one or more Josephson junctions or kinetic inductors. In the exemplary embodiments disclosed herein, a kinetic inductor may refer to a non-linear superconducting inductor whose inductance arises mostly from the inertia of charge carriers in the inductor. In turn, the term “Josephson junction” is used herein in its ordinary meaning and may refer to a quantum mechanical device made of two superconducting electrodes which are separated by a barrier (e.g., a thin insulating tunnel barrier, normal metal, semiconductor, ferromagnet, etc.).

Let us now explain how the above-mentioned mutual cancellation of the quadratic potential energy terms of the linear and non-linear inductive-energy elements impacts the anharmonicity of the superconducting qubit. Assuming that the superconducting qubit is represented as a simple circuit model comprising a linear (geometric) inductor shunting a Josephson junction (or Josephson junctions), the total potential energy of the circuit model reads

$$U = \frac{{E}_{L}}{2} {φ}^{2} - {E}_{J} cos ( φ - {φ}_{e x t} ) , \qquad ( 30 )$$

where φ denotes the superconducting phase difference across the linear inductor,

$${E}_{L} = {( \frac{{Φ}_{0}}{2 π} )}^{2} \frac{1}{L}$$

is the inductive energy of the linear inductor, E_{J} is the Josephson energy of the Josephson junction, and φₑₓₜ is the phase bias of the Josephson junction. Note that such a phase bias could be achieved, for example, with an external magnetic flux Φₑₓₜ=Φ₀φₑₓₜ/(2π) through a loop formed by the Josephson junction and the linear inductor. In this case, a flux quantization condition would relate the superconducting phase differences across the linear inductor and the Josephson junction as

$$- {φ}_{J} + φ = \frac{2 π}{{Φ}_{0}} {Φ}_{e x t} + 2 π m , \qquad ( 31 )$$

where φ_{J} is the superconducting phase difference across the Josephson junction, and m is the integer.

If the phase bias equals φₑₓₜ±π, the quadratic potential energy terms associated with the linear inductor and the Josephson junction have different signs, on account of which they cancel each other at least partly. In other words, the total potential energy may be approximated to the fourth order as follows:

$$U \approx \frac{{E}_{L} - {E}_{J}}{2} {φ}^{2} + \frac{{E}_{J}}{24} {φ}^{4} , \qquad ( 32 )$$

where the cancellation of the quadratic potential energy terms is clearly visible. If E_{L}≈E_{J}, the quartic potential energy term may become large as compared with the quadratic potential energy term, thereby resulting in the high anharmonicity of the superconducting qubit corresponding to the above-assumed circuit model.

In order to estimate the amount of the cancellation quantitatively for the total potential energy U, it should be noted that the potential energy of a phase-biased Josephson junction may be expanded into a Taylor series as

$$- {E}_{J} cos ( φ - {φ}_{e x t} ) = {\sum }_{k = 0}^{∞} \frac{{E}_{J , k} ( {φ}_{e x t} )}{k !} {φ}^{k} , \qquad ( 33 )$$

where E_{J,k}(φₑₓₜ) denotes the k-th Taylor series coefficient of the potential energy of a phase-biased Josephson junction. This allows one to measure the cancellation effect present in the total potential energy U by using the following ratio:

$$\frac{\vert {E}_{L} + {E}_{J , 2} ( {φ}_{e x t} ) \vert}{max ( {E}_{L} , {E}_{J} )} = 1 - β , \qquad ( 34 )$$

where E_{J,2}(φₑₓₜ) denotes the 2^{nd} order Taylor series coefficient of the potential energy of a phase-biased Josephson junction, and β denotes the amount of the cancellation. The cancellation of at least 30% means that β≥0.3. If, for example, the phase bias equals φₑₓₜ=±π, then E_{J,2}=−E_{J} implying that

$$\frac{\vert {E}_{L} + {E}_{J , 2} ( {φ}_{e x t} ) \vert}{max ( {E}_{L} , {E}_{J} )} = \frac{\vert {E}_{L} - {E}_{J} \vert}{max ( {E}_{L} , {E}_{J} )} . \qquad ( 35 )$$

In this case, the requirement of β≥0.3 implies that the Josephson energy and the inductive energy must satisfy

$${E}_{J} / {E}_{L} ∈ [ 0.3 , \frac{1}{0.3} ] .$$

In some embodiments, the above-assumed circuit model may be supplemented with a capacitive-energy element which is also arranged to shunt the Josephson junction. Such a capacitive-energy element may be implemented as one or more interdigitated capacitors, gap capacitors, parallel-plate capacitors, or junction capacitors.

In some embodiments, one or more superconducting qubits each represented by the combination of the phase-biased linear and non-linear inductive-energy elements may be provided on a dielectric substrate. In some embodiments, the superconducting qubits (together with the dielectric substrate) may be further placed inside one or more 3D cavities.

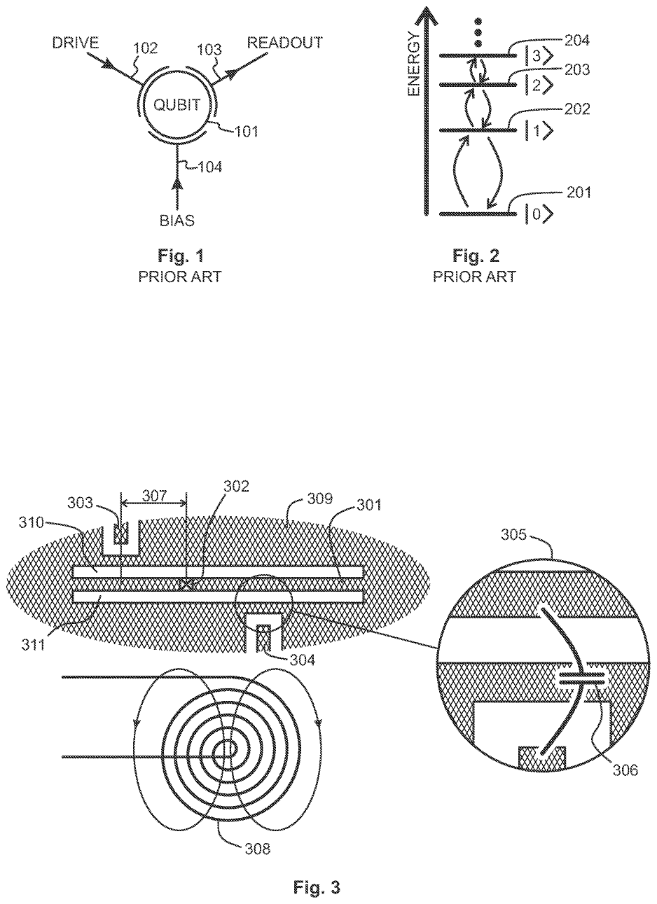

The foregoing may be considered in view of the simple unimon model of FIG. 3. The unimon of FIG. 3 is configured as a CPW resonator comprising the center superconductor 301 and a superconducting ground plane 309. The superconductor 301 is galvanically connected to the superconducting ground plane 309 at a pair of opposite ends. At the same time, the superconductor 301 is separated by equal gaps 310 and 311 from the superconducting ground plane 309 on a second pair of opposite sides (i.e. top and bottom sides, as shown in FIG. 3). In this case, the superconductor 301 serves as the linear inductive-energy element of the unimon. A non-linear inductive-energy element is represented by the (here: single) Josephson junction 302 embedded in the superconductor 301 such that the circuit of FIG. 3 is free of superconducting islands. In general, a superconducting island may refer to a Cooper-pair box connected via a tunnel junction to the center superconductor 301. As another example, a superconducting island would be formed between two Josephson junctions embedded in series within the center conductor. It should be noted that elements in FIG. 2 are not shown to scale for convenience. Furthermore, the shape of the center superconductor 301 and the superconducting ground plane 309 are also illustrative and may be modified, depending on particular applications.

In place of the CPW resonator, there could be used any type of a distributed-element resonator (one example of which is the CPW resonator). Additionally or alternatively, the unimon may be configured as any other combination of linear and non-linear inductive-energy elements configured to be phase-biased such that their quadratic potential energy terms are at least partly cancelled by one another.

As for the Josephson junction 302, it may interrupt the center superconductor 301, as shown in FIG. 3. In one embodiment, the Josephson junction 302 may be embedded in the center superconductor 301 such that a current flowing through the center superconductor 301 is equal on both sides of the Josephson junction 302. In another embodiment, the Josephson junction 302 is centrally arranged in the center superconductor 301.

To provide the above-mentioned cancellation, the arrangement should also comprise a phase-biasing element, of which the inductive element 308 is an example. In the first embodiment, the phase-biasing element is intended to be configured to generate and thread a magnetic flux φ_{ext,1} and Φ_{ext,2} through the gaps, i.e., loops, 310 and 311, thereby providing phase biasing in a proper manner. Thanks to the two parallel loops, the unimon of FIG. 3 is gradiometric, meaning that it is protected against flux noise whose spatial scale exceeds its width. This phase biasing leads to at least partial mutual cancellation of the quadratic potential energy terms of the superconductor 301 and the Josephson junction 302, thereby improving anharmonicity. The phase-biasing element may comprise one or more coils and/or one or more flux-bias lines for providing magnetic flux control. A flux-bias line may be implemented as a superconducting wire on the dielectric substrate, and magnetic fields may be generated by tuning a current flowing through the wire. In some other embodiments, such a phase-biasing element may be configured to provide the phase biasing by applying a suitable voltage to the Josephson junction 302, instead of or in addition to threading the magnetic field through the gaps 310 and 311.

Since the Josephson junction 302 is embedded in the CPW resonator such that no isolated superconducting islands are formed, the inductance and the capacitance of the CPW resonator shunt the Josephson junction 302 and provide protection against dephasing arising from low-frequency charge noise. Due to the inductive shunt, the unimon of FIG. 3 should be fully immune to the low-frequency charge noise due to its topology unlike e.g. the commonly employed transmon qubits, where only the few lowest energy levels are well protected against charge noise.

As can be seen in FIG. 3, the superconducting ground plane 309 comprises opposite upper and lower portions which are physically separated from each other by the center superconductor 301 and the gaps 310, 311. In one embodiment, these opposite portions may be connected with each other via air bridges stretching over the center superconductor 301 and gaps 310, 311 in order to suppress parasitic slot line modes of the CPW resonator.

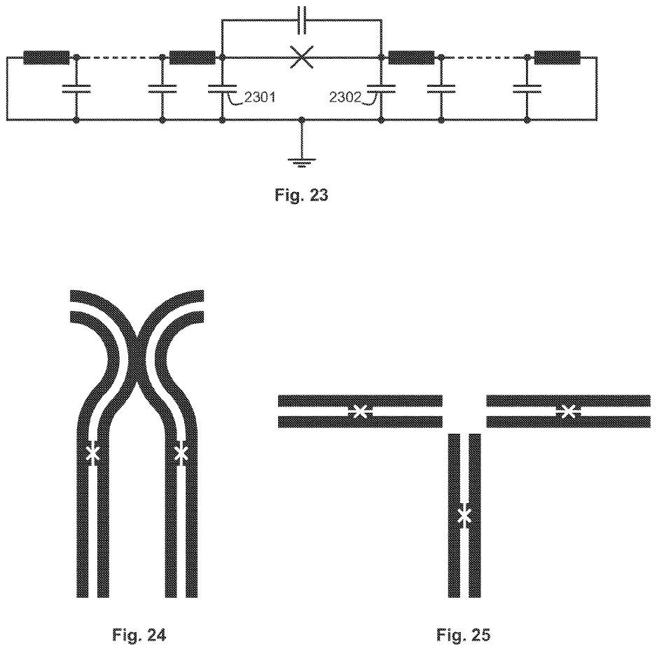

FIG. 23 shows a circuit model used for deriving the Hamiltonian of the unimon of FIG. 3 when it is subjected to an external magnetic flux. According to the circuit model, the CPW resonator of length 2l is modeled by using N lumped element inductors and capacitors. Additionally, the Josephson junction 302 is assumed to be arranged between capacitors 2301 and 2302 with indices J and J+1. Due to the gradiometric nature of the two loops, the external magnetic flux in the following calculations is regarded as the (scaled) difference of the external magnetic fluxes on the two sides of the center superconductor 301, i.e. φ_{diff}=(Φ_{ext,2}−Φ_{ext,1})/2. By using the circuit model of FIG. 23, it is possible to write a classical kinetic energy term T and a potential energy term U for the circuit as

$$T = {\sum }_{i = 1}^{N} \frac{1}{2} {c}_{t o t} Δ x {\dot{Ψ}}_{i}^{2} + \frac{1}{2} {{C}_{J} ( {\dot{Ψ}}_{J + 1} - {\dot{Ψ}}_{J} )}^{2} , \qquad ( 36 )$$

$$\begin{matrix}U = \frac{1}{2 {l}_{t o t} Δ x} {( - {Ψ}_{1} + {Φ}_{diff , 1} )}^{2} \\ + \frac{1}{2 {l}_{t o t} Δ x} {\sum }_{i = 2 , i \neq J + 1}^{N} {( {Ψ}_{i - 1} - {Ψ}_{i} + {Φ}_{diff , i} )}^{2} \\ + \frac{1}{2 {l}_{t o t} Δ x} {( {Ψ}_{N} + {Φ}_{diff , N} )}^{2} \\ - {E}_{J} cos ( \frac{2 π}{{Φ}_{0}} ( {Ψ}_{J + 1} - {Ψ}_{J} ) ) ,\end{matrix} \qquad ( 37 )$$

where

$${Ψ}_{i} = {\int }_{- ∞}^{t} {V}_{i} ( τ ) d τ$$

is the node flux across the i-th capacitor with voltage Vᵢ, Φ_{diff,i} is the external magnetic flux across the i-th loop, Δx=2l/N is the length scale for discretization, cₜₒₜ is the total capacitance per unit length of the CPW resonator, lₜₒₜ is the total inductance per unit length of the CPW resonator, E_{J} is the Josephson energy, C_{J} is the capacitance of the Josephson junction 302, and Φ₀ is the flux quantum as above. Additionally, the dots over the symbols denote time derivatives.

Using the Lagrangian formalism, one may then derive the classical equation of motion for the node fluxes within the CPW resonator. In the continuum limit Δx→0, one may obtain the following result:

$${c}_{t o t} \ddot{ψ} = \frac{1}{{l}_{t o t}} {\partial }_{x x} ψ - \frac{s}{{l}_{t o t}} {\partial }_{x} {B}_{diff ,} \qquad ( 38 )$$

where Ψᵢ→ψ(xᵢ) corresponds to the continuum limit of the node flux at location xᵢ, Φ_{diff,i}/(sΔx)→B_{diff} denotes the effective magnetic field difference, and s is the distance between the center superconductor 301 and the superconducting ground plane 309. Using the Lagrangian formalism, one may also derive a boundary condition for the node flux at the location

$${x}_{J}^{-}$$

corresponding to the left electrode of the Josephson junction 302:

$$- {C}_{J} Δ \ddot{ψ} - {I}_{c} sin ( \frac{2 π}{{Φ}_{0}} Δ ψ ) = - \frac{1}{{l}_{t o t}} {\partial }_{x} ψ {\vert}_{x = {x}_{J}^{-}} + \frac{{Φ}_{diff}}{2 l {l}_{tot}} , \qquad ( 39 )$$

where Δψ=Ψ_{J+1}-Ψⱼ is the branch flux across the Josephson junction 302, I_{c}=2πE_{J}/Φ₀ is the critical current of the Josephson junction 302, and Φ_{diff}=ΣᵢΦ_{diff,i} is the total external magnetic flux difference. In the above equation, the assumption of a homogenous magnetic field has been utilized to write Φ_{diff,J}/Δx→Φ_{diff}/(2l), where 2l is the length of the center superconductor 301. Note that a similar boundary condition may be derived for the right electrode of the Josephson junction 302. Additional boundary conditions ψ(−1)=0 and ψ(l)=0 arise from the grounding of the center superconductor 301.

Based on the classical equation of motion and the boundary conditions, it follows that the (classical) generalized flux may be described as a linear combination of a dc supercurrent and an infinite number of oscillatory normal modes, namely:

$$ψ ( x , t ) = {ϕ}_{0} {u}_{0} ( x ) + {\sum }_{n \geq 1} {u}_{n} ( x ) {ψ}_{n} ( t ) , \qquad ( 40 )$$

where φ₀ is the time-independent coefficient of the “dc mode”, and u₀(x) is the corresponding envelope function. In intuitive terms, the dc supercurrent biases the Josephson junction 302, which changes the effective Josephson inductance seen by the oscillatory (ac) normal modes. Here, {uₙ(x)} are the envelope functions of the oscillatory ac modes and {ψₙ(t)} are the corresponding time-dependent coefficients. Importantly, the envelope functions and the corresponding mode frequencies may be derived using the above equation of motion and the above boundary conditions.

To use the CPW resonator with the embedded Josephson junction 302 as a unimon, one should observe that the non-linearity of the Josephson junction 302 turns some of the normal modes into anharmonic oscillators. In the following, we focus on the m-th mode and assume that we would like to operate the unimon as a qubit. With this in mind, it is possible to derive a single-mode approximation for the quantum Hamiltonian that is given by

$${\hat{H}}_{m} = 4 {E}_{C , m}^{′} ( {φ}_{0} ) {\hat{n}}_{m}^{2} + \frac{1}{2} {E}_{L , m} ( {φ}_{0} ) {\hat{φ}}_{m}^{2} + {E}_{L} {\hat{φ}}_{m} ( {φ}_{diff} - {φ}_{0} ) - {E}_{J} cos ( {\hat{φ}}_{m} - {φ}_{0} ) , \qquad ( 41 )$$

where

$${E}_{C , m}^{′} ( {φ}_{0} )$$

is the effective charging energy associated with the m-th mode, \hat{n}ₘ is the charge operator of the m-th mode, E_{L,m}(Φ₀) is the effective inductive energy of the m-th mode, \hat{φ}ₘ is the phase operator corresponding to the m-th mode,

$${E}_{L} = {Φ}_{0}^{2} / {( 2 π )}^{2} / ( 2 {ll}_{t o t} )$$

is the inductive energy associated with the total linear inductance of the CPW resonator, φ₀=2πφ₀/Φ₀ is the phase bias corresponding to the dc current, and φ_{diff}=2π_{diff}/Φ₀ denotes the phase associated with the external magnetic flux. Note that the phase and charge operators are conjugate operators satisfying the commutation relation [\hat{φ}ₘ, \hat{n}ₘ]=i, where i is the imaginary unit.

It should be noted that the m-th mode of the unimon is treated quantum-mechanically in the above Hamiltonian, but the dc Josephson phase φ₀ is treated as a static variable that is computed based on a semiclassical theory. According to the semiclassical theory, the dc Josephson phase is given by the following flux quantization condition:

$${I}_{c} sin ( \frac{2 π}{{Φ}_{0}} {ϕ}_{0} ) + \frac{{ϕ}_{0}}{2 {ll}_{t o t}} = \frac{{Φ}_{diff}}{2 l {l}_{t o t}} , \qquad ( 42 )$$

where φ₀=Φ₀φ₀/(2π) is the branch flux associated with the dc Josephson phase.

In general, the anharmonicity αₘ/(2π) of a given mode may be computed numerically by performing the following steps:
at first, determining the dc Josephson phase using the above-given flux quantization condition;
then, solving the (classical) normal mode frequencies using the following equation that has been derived from the above equation of motion and the above boundary conditions:

$${k}_{m} l cos ( {k}_{m} ( {x}_{J} - l ) ) cos ( {k}_{m} ( {x}_{J} + l ) ) - ( \frac{{{C}_{J} ( {k}_{m} l )}^{2}}{{c}_{t o t} l} - \frac{{l}_{t o t} l}{{L}_{J}} cos ( \frac{2 π {ϕ}_{0}}{{Φ}_{0}} ) ) sin ( 2 {k}_{m} l ) = 0 , \qquad ( 43 )$$

where kₘ=ωₘ\sqrt{cₜₒₜlₜₒₜ} is the wavenumber of the m-th mode, and L_{J}=Φ₀/(2πl_{c}) is the effective Josephson inductance; and
finally, numerically diagonalizing the single-mode Hamiltonian Ĥₘ to obtain the quantized energy spectrum of the mode of interest for a given external magnetic flux. Using the energy spectrum of the m-th mode, it is straightforward to evaluate the qubit frequency ω_{q}/(2π) and the corresponding anharmonicity αₘ/(2π).

Due to the large capacitance per unit length of the CPW resonator, the anharmonicity of the unimon is only modest unless the parameters of the circuit model 200 are chosen suitably, and an appropriate external magnetic flux is applied. However, if the external magnetic flux equals half of the flux quantum, i.e., Φ_{diff}/Φ₀=±0.5, the dc Josephson phase equals φ₀=±π assuming that the Josephson inductance is larger than the total inductance of the CPW resonator. If the linear inductance of the CPW resonator is only slightly smaller than the Josephson inductance, the quadratic potential energy terms associated with the inductive energy E_{L,m}(φ₀) and the Josephson energy E_{J} cancel each other almost completely, which can result in a large anharmonicity. Using experimentally attainable values of the parameters for the circuit model 200, it has been found that the anharmonicity of the lowest-frequency mode may (greatly) exceed 500 MHz for a qubit frequency of approximately 5 GHz if the external magnetic flux is tuned to φ_{diff}/Φ₀±0.5. It is necessary to note that this also corresponds to a flux-insensitive sweet spot protecting the unimon against the dephasing induced by the flux noise.

To improve the anharmonicity further, one may fabricate the center superconductor 301 of the CPW resonator from a superconducting material with a high-kinetic inductance, such as a superconducting thin film. This would increase the inductance of the CPW resonator with respect to the capacitance. As a result, the total capacitance of the CPW resonator could be reduced, which would improve the anharmonicity of the unimon. In such a circuit model, the anharmonicity could exceed 200 MHz even in the absence of an external magnetic flux, and greatly exceed 1 GHz with the external magnetic flux. However, superconducting thin films tend to be relatively lossy and, therefore, the increase in the anharmonicity might be accompanied by a significant decrease in the relaxation and coherence times. For this reason, the approach based on an external flux without any superconducting thin films seems the most promising path towards a high-coherence high-anharmonicity superconducting qubit.

FIGS. 24 and 25 show examples of schematic capacitive and inductive couplings between unimons. More specifically, FIG. 24 shows a schematic top view of a quantum circuit comprising a combination of two unimons capacitively coupled to each other. FIG. 25 shows a schematic top view of a quantum circuit comprising a combination of three unimons inductively coupled to each other. In FIGS. 24 and 25, white color denotes the center superconductor, the superconducting ground plane, and the Josephson junction in each unimon, while the black color denotes the gaps and in the superconducting material on the surface of the substrate. It should be apparent to those skilled in the art that the number of the unimons 104 shown in FIGS. 24 and 25 is for illustrative purposes only and should not be construed as any limitation. Moreover, it should be again noted that the size of the structural elements are not necessarily shown to scale.

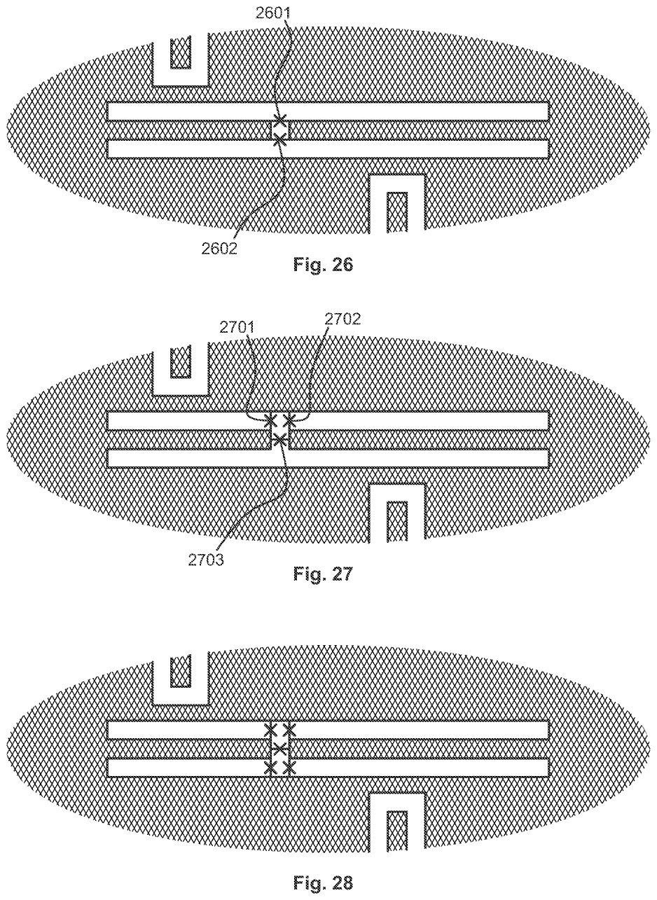

FIGS. 26, 27, and 28 show schematic top views of some possible unimons. These unimons differ from that of FIG. 3 and from each other in the number and location of Josephson junctions. In FIG. 26, the non-linear inductive-energy element is represented by a combination of two parallel Josephson junctions 2601 and 2602 embedded in the superconductor 906 such that the QPU 900 is free of superconducting islands. Such an arrangement of the Josephson junctions 914 and 916 forms a SQUID loop, where the phase biasing may be provided by threading a magnetic field through the gaps and the SQUID loop.

In FIG. 27, the non-linear inductive-energy element is represented by a combination of three Josephson junctions 2701, 2702, and 2703. Of these, the Josephson junction 2703 is embedded in the center superconductor, while the Josephson junctions 2701 and 2702 are arranged in the top gap in the vicinity of the third Josephson junction 2703 such that the two Josephson junctions 2701 and 2702 connect the center superconductor to the ground plane. One of the Josephson junctions 2701 and 2702 may be omitted or may be arranged in the other bottom gap in the vicinity of the third Josephson junction 2703. Again, the circuit is free of superconducting islands. In the meantime, the phase biasing may be provided by the same manner as in the first embodiment, i.e. by threading the magnetic field through the gaps.

FIG. 28 shows a schematic top view of a unimon in which non-linear inductive-energy element is represented by a combination of five Josephson junctions, one of which is embedded in the center superconductor while the four others are arranged in the gaps in the vicinity to connect the center superconductor to the ground plane across both the top and bottom gaps. Also this circuit is free of superconducting islands. The phase biasing may be provided by the same manner as above, i.e. by threading the magnetic field through the gaps.

If there is an even number of Josephson junctions arranged in the gaps between the center superconductor and the superconducting ground plane, these Josephson junctions may be arranged symmetrically or asymmetrically relative to the Josephson junction embedded in the center superconductor, depending on particular applications.

The schematic representations of FIGS. 24 to 28 intentionally omit further circuit elements, like control signal lines and/or readout lines provided on the dielectric substrate.

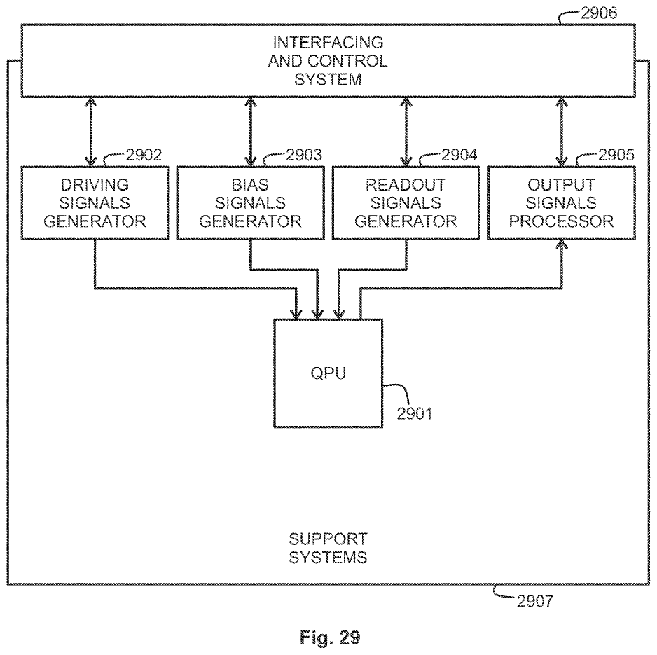

FIG. 29 illustrates schematically a quantum information processing system. The one or more bosonic quantum mechanical systems, the driving of which should involve suppressing the predetermined further transitions between energy states, are included in a quantum processing unit (QPU) 2901. The one or more driving signals generators for generating the driving signals are included in the driving signals generator block 2902, from which the necessary couplings go to the bosonic quantum mechanical system(s) in the QPU 2901. One or more bias signals generators may be included in block 2903 are coupled to said bosonic quantum mechanical system(s) and configured to generate bias signals for said bosonic quantum mechanical system, if necessary. One or more readout signals generators may be included in block 2904 and coupled to said bosonic quantum mechanical system(s), configured to generate readout signals for said bosonic quantum mechanical system. One or more output signals processors 2905 may be coupled to said bosonic quantum mechanical system(s) and configured to process output signals from said bosonic quantum mechanical system(s).

An interfacing and control system 2906 is coupled to the driving signal generator(s) 2902, bias signals generator(s) 2903, readout signals generator(s) 2904, and output signals processor(s) 2905 for controlling the operation of the quantum information processing system and for offering an interface towards classical computing systems (not shown in FIG. 29). One or more support systems 2907 may be provided for supporting functions, like cooling the appropriate parts of the quantum information processing system to the low temperatures that are typically required, providing operating power to the parts of the quantum information processing system, and so on.

It is obvious to a person skilled in the art that with the advancement of technology, the basic idea of the invention may be implemented in various ways. The invention and its embodiments are thus not limited to the examples described above, instead they may vary within the scope of the claims.

1. A method for driving a bosonic quantum mechanical system capable of exhibiting transitions between a plurality of eigenstates, the method comprising:
driving said quantum mechanical system with two or more simultaneous driving signals, each of which has a respective driving signal amplitude, frequency, and phase, and
coupling said two or more simultaneous driving signals to said quantum mechanical system through couplings of respective coupling strength at respective coupling locations in relation to a physical appearance of said system;
wherein a selected combination of said driving signal amplitudes, frequencies, and phases; said coupling strengths; and said coupling locations intentionally causes said driving to suppress at least one of said transitions,
selecting values for said driving signal amplitudes, frequencies, and phases: coupling strengths; and coupling locations in a way that minimizes at least one transition matrix element M_{k,l} of a transition matrix between low-energy eigenstates of the quantum mechanical system caused by said driving signals, wherein k and 1 are indices of two of said eigenstates, and wherein
said selecting of values for said driving signal amplitudes, frequencies, phases, coupling strengths, and coupling locations comprises:
deriving the Hamiltonian of the bosonic quantum mechanical system under interest,
determining a low-energy eigenspace of the bosonic quantum mechanical system under interest by diagonalizing the Hamiltonian,
determining the formulae for the transition matrix elements M_{k,l} between low-energy eigenstates caused by drive fields of the bosonic quantum mechanical system, by calculating the overlap between said low-energy eigenstates against the drive Hamiltonian, said formulae being functions of the driving signal amplitudes, frequencies, phases, coupling strengths, and the coupling locations,
solving the set of equations Mₖ_{ⱼ}_{,l}_{ⱼ}=0 for all index pairs (kⱼ, lⱼ) corresponding to states transitions between which are to be suppressed, and
selecting (i) the driving signal amplitudes, frequencies, and phases, (ii) coupling strengths, and (iii) coupling locations given by solving the set of equations.

2. A method according to claim 1, wherein said coupling of said two or more simultaneous driving signals to said quantum mechanical system involves using capacitive coupling, so that said respective coupling strengths are functions of the capacitances of the respective capacitive couplings.

3. A method according to claim 1, wherein said driving signals are oscillating voltage signals, so that said respective driving signal amplitudes are amplitudes in voltage.

4. (canceled)

5. (canceled)

6. A method according to claim 1, wherein:
said bosonic quantum mechanical system is a part of a quantum information processing system,
two of said plurality of eigenstates are basis states of a computational basis of said quantum information processing system, and
said selected combination of (i) said driving signal amplitudes, frequencies, and phases, (ii) said coupling strengths, and (iii) said coupling locations intentionally drives a transition between said basis states and simultaneously causes said driving to suppress at least one further transition.

7. A method according to claim 1, wherein:
said quantum mechanical system comprises a unimon, which comprises a coplanar waveguide, intercepted by at least one Josephson junction, and has a length between its two ends, and
said coupling of said two or more simultaneous driving signals to said quantum mechanical system comprises coupling said driving signals to said unimon at respective two or more different locations along the length of said coplanar waveguide.

8. A quantum information processing system, comprising:
a bosonic quantum mechanical system capable of exhibiting transitions between a plurality of eigenstates, and
one or more driving signal generators configured to generate driving signals with a respective driving signal amplitude, frequency, and phase;
wherein said quantum information processing system is configured to drive said bosonic quantum mechanical system with two or more of said driving signals simultaneously, coupled to said quantum mechanical system through couplings of respective coupling strength at respective coupling locations in relation to a physical appearance of said system, in a selected combination of (i)said driving signal amplitudes, frequencies, and phases, (ii) said coupling strengths, and (iii) said coupling locations to intentionally cause said driving to suppress at least one of said transitions.

9. A quantum information processing system according to claim 8, wherein:
two of said plurality of eigenstates are basis states of a computational basis of said quantum information processing system, and
said quantum information processing system is configured to drive said bosonic quantum mechanical system with (i) said selected combination of said driving signal amplitudes, frequencies, and phases, (ii) said coupling strengths, and (iii) said coupling locations to intentionally drive a transition between said basis states and to simultaneously cause said driving to suppress at least one further transition.

10. A quantum information processing system according to claim 8, wherein said quantum mechanical system comprises at least one subsystem that is driven with said driving signals and utilized as a qubit or a qudit.

11. A quantum information processing system according to claim 8, comprising at least one unimon, which comprises a coplanar waveguide, intercepted by at least one Josephson junction, and has a length between its two ends, and
the quantum information processing system comprises couplings for coupling said two or more simultaneous driving signals to said unimon at respective two or more different locations along the length of said coplanar waveguide.

12. A quantum information processing system according to claim 8, comprising:
a bias signals generator coupled to said bosonic quantum mechanical system and configured to generate bias signals for said bosonic quantum mechanical system,
a readout signals generator coupled to said bosonic quantum mechanical system and configured to generate readout signals for said bosonic quantum mechanical system,
an output signals processor coupled to said bosonic quantum mechanical system and configured to process output signals from said bosonic quantum mechanical system, and
an interfacing and control system coupled to said one or more driving signal generators, to said bias signals generator, to said readout signals generator, and to said output signals processor for controlling operation of the quantum information processing system.
